(19) United States
(12) Patent Application Publication
(10) Pub. No.: US 2010/0284048 A1
(43) Pub. Date: Nov. 11, 2010

(54) Techniques for obtaining scanning images and scanning device for the same

(75) Inventors: ALPHA HOU, SAN JOSE, CA (US); QIANG LI, WUHAM (CN); ZAIJUN XI, WUHAN (CN); FEI ZHANG, WUHAN (CN); JUAN MA, WUHAN (CN); ZHI GUI, WUHAN (CN)

Correspondence Address: SILICON VALLEY PATENT AGENCY, 7394 WILDFLOWER WAY, CUPERTINO, CA, 95014, US

(73) Assignee: SHENZHEN SYSCAN TECHNOLOGY CO., LIMITED.

(21) Appl. No.: 12/701,499

(22) Filed: Feb. 5, 2010

(30) Foreign Application Priority Data
May 7, 2009 (CN) 200910107233.0

(51) Int. Cl. H04N 1/04

(52) U.S. Cl. 358/486

(57) ABSTRACT

Techniques for scanning an object that does not fit upon a scan surface of a scanner and requires a non-linear scanning path are described. In one embodiment, a pair of optical navigation sensors and an image sensor (e.g., CIS) are used to determine coordinates and an angle of a scanning object. By acquiring the coordinates of optical navigation sensors with respect to the image sensor after each relative movement between the image sensor and the scanning object, coordinates of pixel points on the image sensor can be readily determined as long as there is a predefined geometry between the optical navigation sensors and the image sensor. In addition, scanned image data can be modified, enhanced or corrected in scanning or in memory.

### BACKGROUND OF THE INVENTION

1. Field of the Invention

The present invention relates to the area of document scanning technology, and particularly to techniques for obtaining scanning images and scanning devices for implementing the same.

2. Description of Prior Art

Scanners can be generally classified into flatbed scanners and feed-in scanners. The scanning principle for the both is that an internal light is first impinged onto a document being scanned through a contact image sensor (CIS), and the CIS then senses the light reflected back from the document. The optical signal received by the CIS is converted into an electronic signal which is further converted into a digital signal by an AD conversion circuit. The digital signal is finally transferred to a host machine to complete the scanning process.

Flatbed scanners are limited to documents that fit upon its scanning surface, while feed-in scanners permits scanning of documents that fit within the width of the scanner, regardless of the length. However, both types of scanners require the CIS to linearly move along the object being scanned or vice versa. This is not suitable for an object that does not fit upon a scan surface of the scanner and that requires a non-linear scanning path.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques of obtaining scanning images of an object that does not fit upon a scan surface of a scanner and requires a non-linear scanning path. According to one aspect of the present invention, a scanning method is provided and comprises: A method for obtaining a scanned image, the method comprising:
(a) acquiring terminal coordinates (x₁, y₁) and (x_{N}, y_{N}) of a contact image sensor according to respective initial coordinates (x₀₀, y₀₀) and (₀₁, y₀₁) of two optical navigation sensors and a positional relationship between the two optical navigation sensors and the contact image sensor before a relative movement between a scanning device and a scanning object;
(b) acquiring coordinates (xₙ, yₙ) of a pixel point on the contact image sensor;
(c) obtaining a pixel value for each of pixels on the contact image sensor;
(d) determining offsets of the two optical navigation sensors along X-axis direction and Y-axis direction, after the relative movement is made, to obtain current coordinate values of the two optical navigation sensors, wherein the current coordinate values of the two optical navigation sensors are taken as initial coordinates (x₀₀, y₀₀) and (x₀₁, y₀₁) of the two optical navigation sensors before a next relative movement between the scanning device and the scanning object; and
repeating (a) through (d) until the scanning object is completely scanned by the contact image sensor.

According to another aspect of the invention, a correction unit is provided to modify, enhance or correct one or more pixel values from the contact image sensor. Depending on implementation, the correction unit may be used to correct pixel values that are wrongly generated or generated with undesired effect. In still another aspect of the invention, a correction is made in conjunction with correcting coefficients that are obtained in advance by scanning pre-defined templates.

The present invention may be implemented in many forms including an apparatus, a method and part of a system. In one embodiment, the present invention is a scanning device that comprises: first and second optical navigation sensors for determining coordinates and an angle of a scanning object; a contact image sensor for scanning images disposed near the optical navigation sensors to form a geometry pattern from which two ending coordinates of the contact image sensor are obtained in conjunction with coordinates of the first and second optical navigation sensors that are determined after a relative movement of the contact image sensor and the scanning object; a coordinate acquiring unit for acquiring coordinates (xₙ, yₙ) of each of pixel points of the contact image sensor in accordance with; and a memory space for storing pixel values generated from the contact image as the scanning object is being scanned by the contact image sensor.

One of the objects, features, and advantages of the present invention is to provide scanning techniques for scanning an object that does not fit upon a scan surface of a scanner and requires a non-linear scanning path.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a schematic view illustrating a geometrical positional relationship between several elements of a scanning device according to one embodiment of the present invention;

FIG. 2 is a CIS in a two-dimensional coordinate system;

FIG. 3 is a process or flowchart of obtaining scanning images according to one embodiment of the present invention;

FIG. 4 is a functional block diagram of an exemplary system for obtaining scanning images according to one embodiment of the present invention; and

FIG. 5 is a functional block diagram of an exemplary scanning device according to one embodiment of the present invention.

### DETAILED DESCRIPTION OF THE PREFERRED EMBODIMENTS

The detailed description of the invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art.

Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

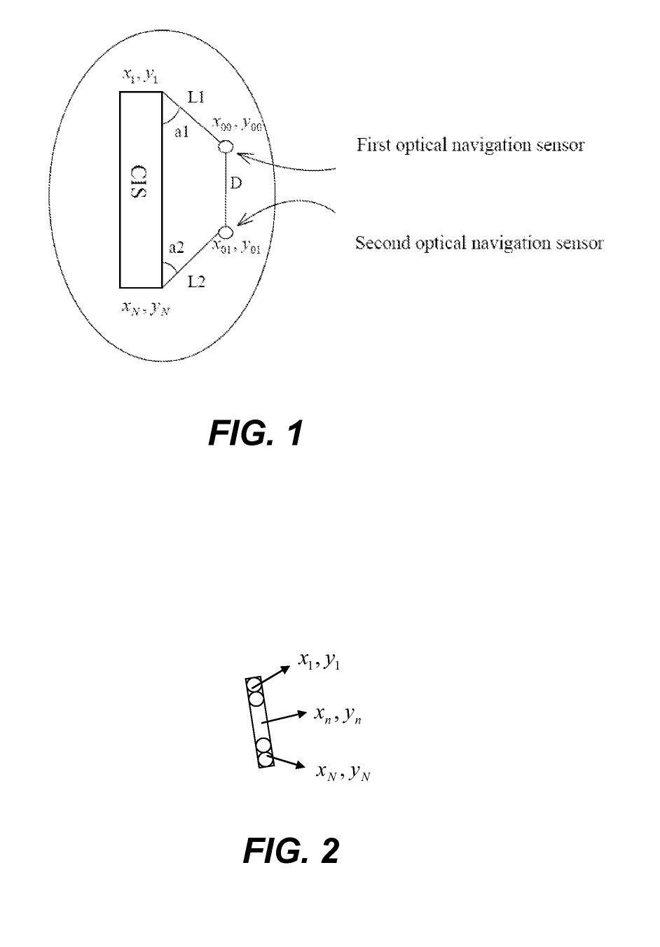

Referring now to the drawings, in which like numerals refer to like parts throughout the several views. As shown in FIGS. 1 and 2, a scanning device includes a first optical navigation sensor, a second optical navigation sensor and a CIS disposed opposite to a line joining the two optical navigation sensors. In one embodiment, the CIS is disposed parallel to the line joining the two optical navigation sensors. It is understood that non-parallel arrangement is also feasible, since the coordinates of each pixel point on the CIS can be calculated through the coordinates of the two optical navigation sensors, as long as the geometrical positional relationship between the CIS and the two optical navigation sensors is known. As such calculation can be readily made by one skilled in the art, a detailed description thereof is omitted herein.

A linear distance between the first optical navigation sensor ONS1 and the second optical navigation sensor ONS2 remains a constant D. To facilitate the description of the present invention, it is assumed that two respective coordinates of the two optical navigation sensors are (x₀₀, y₀₀) and (x₀₁, y₀₁), the terminal coordinates of the contact image sensor are (x₁, y₁) and (x_{N}, y_{N}). The linear distance between the first optical navigation sensor and the proximal end of the CIS and the linear distance between the second optical navigation sensor and the other end of the CIS are respectively L1 and L2, the angle formed between the CIS and a line joining the first optical navigation sensor and the proximal end of the CIS is a1. The angle formed between the CIS and a line joining the second optical navigation sensor and the other end of the CIS is a2. The terminal coordinates (x₁, y₁) and (x_{N}, y_{N}) of the CIS can be readily calculated according to the geometrical positional relationship between these elements.

Based on the terminal coordinates (x₁, y₁) and (x_{N}, y_{N}) of the CIS, coordinates (xₙ, yₙ) of any pixel point on the CIS also can be readily obtained by one skilled in the art.

After obtaining the coordinates of all pixel points on the CIS, corresponding gray value or chromaticity value of each pixel point on the CIS is generated in turn and saved in a predetermined buffer area (e.g., a memory area) according to the coordinates of the pixel point. As there is a relative movement between the scanning device and the scanning object, the CIS generates signals or data repeatedly until the gray values or chromaticity values of all pixel points in a scanning area are completely filled in the buffer area.

In operation, when the scanning device is moved, the offset amounts of the two optical navigation sensors in the X-axis direction and the Y-axis direction are determined to obtain the current coordinates of the two optical navigation sensors. The current coordinates of the two optical navigation sensors are then taken as the initial coordinates (x₀₀, y₀₀) and (x₀₁, y₀₁) of the two optical navigation sensors before a next movement of the scanning device.

It can be understood that, in the scanning process, the coordinates of the first and second optical navigation sensors for each movement of the CIS can be obtained by the above method. The coordinate (xₙ, yₙ) of a pixel point on the CIS can then be calculated accordingly. The corresponding gray value or chromaticity value of this arbitrary pixel point is filled in the predetermined buffer area according to its coordinates (xₙ, yₙ). When scanning is finished, that is, the CIS completely moves over the object being scanned, an entire scanning image can be acquired in the predetermined buffer area.

As there is a relative movement of the CIS and the scanning object, the response of each pixel point on the CIS to the same gray value or chromaticity value may be different from each other, correction of the gray value or chromaticity value of any pixel point may be done. According to one embodiment, the correction may be performed as follows: scanning a pure white template and a pure black template with the CIS to obtain a corresponding gray or chromaticity value of respective pixel points on the CIS, and obtaining a correction coefficient of each pixel point based on the obtained test values that may be used to correct scanning values in actual scanning.

Those skilled in the art understand that the correction method is also applicable to a color-based CIS. Specifically, the gray or chromaticity value for each color could be corrected if needed. After obtaining the gray or chromaticity values in the buffer area, brightness and contrast correction of the image may also be adjusted. The image in the buffer can then be displayed via an application program (e.g., Adobe Photoshop).

When scanning is finished, various interfaces for image rotation, cropping or other utilities may be provided so as to realize adjustment of the scanned image. Additional functions including image storing, printing, zooming, and so on, may be further provided. In one embodiment, a host computer (e.g., a personal computer) may be used to run an application to display a scanned image and process it as desired.

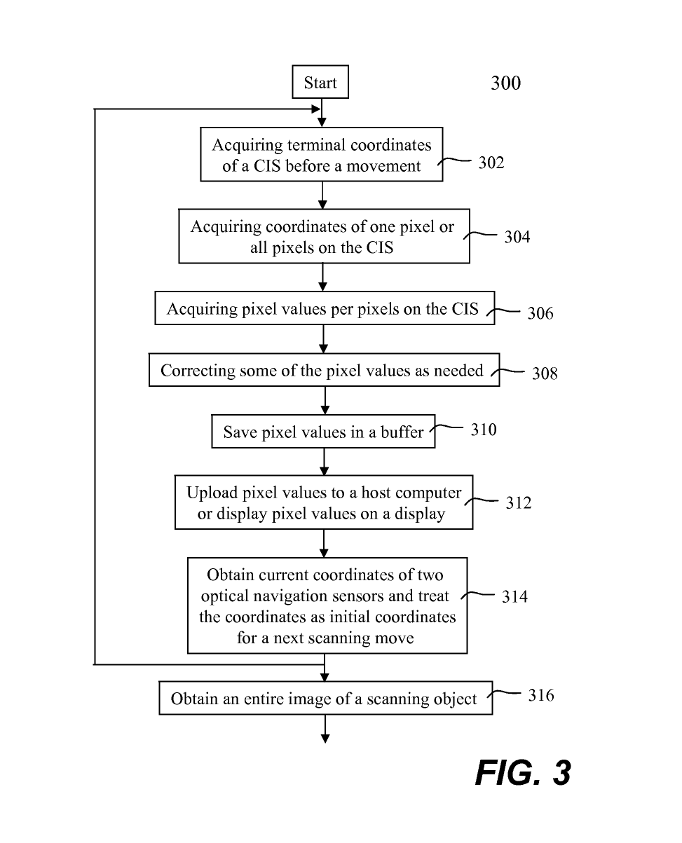

FIG. 3 is a flowchart or process 100 of scanning an object that does not fit upon a scan surface of a scanner and requiring possibly a non-linear scanning path according to one embodiment of the present invention. The process 100 can be implemented in a combination of hardware and software.

Terminal coordinates (x₁, y₁) and (x_{N}, y_{N}) of a contact image sensor are obtained at 302 according to respective coordinates (x₀₀, y₀₀) and (x₀₁, y₀₁) of two optical navigation sensors and the positional relationship between the two optical navigation sensors and the contact image sensor. At 304, the coordinates (xₙ, yₙ) of one or every pixel on the contact image sensor are acquiring according to the terminal coordinates (x₁, y₁) and (x_{N}, y_{N}) of the contact image sensor. It should be noted that once coordinates of one pixel are determined, the rest of the pixels on the CIS can be readily calculated.

Image data or pixel values on each of the pixel points on the CIS are generated and obtained (e.g., an analog signal is digitized via an ADC) at 304. Some of the pixel values may be corrected at 308 if needed according to correction coefficients obtained in a testing phase. At 310, the pixel values or corrected version thereof are stored in a buffer or memory space according to their coordinates (xₙ, ₙ), where n=0 . . . k, k is the number of pixels the CIS has. In one embodiment, the saved pixel values are displayed on a display device (resulting in a progressive display of a scanning object) at 312.

At 314, the offsets of the two optical navigation sensors in the X-axis direction and the Y-axis direction are determined. As indicated above, the scanning path may not be a straight line after a relative movement of the scanning device and the scanning object. The current coordinate values of the two optical navigation sensors are then determined with the offsets and are taken as new initial coordinates (x₀₀, y₀₀) and (x₀₁, y₀₁) of the two optical navigation sensors before the next (relative) movement of the scanning device.

At this point, the process 300 has finished a scanning line and goes back to 302 to start another scanning line as a result of another relative movement between the CIS and the scanning object. The process 300 is repeated till the scanning object is entirely scanned. At 316, a scanned image is obtained.

In one embodiment, the scanned image may be further enhanced or automatically modified. For example, to correct the brightness and contrast of the image in the buffer, a step of correcting the brightness and contrast can be further included after 316.

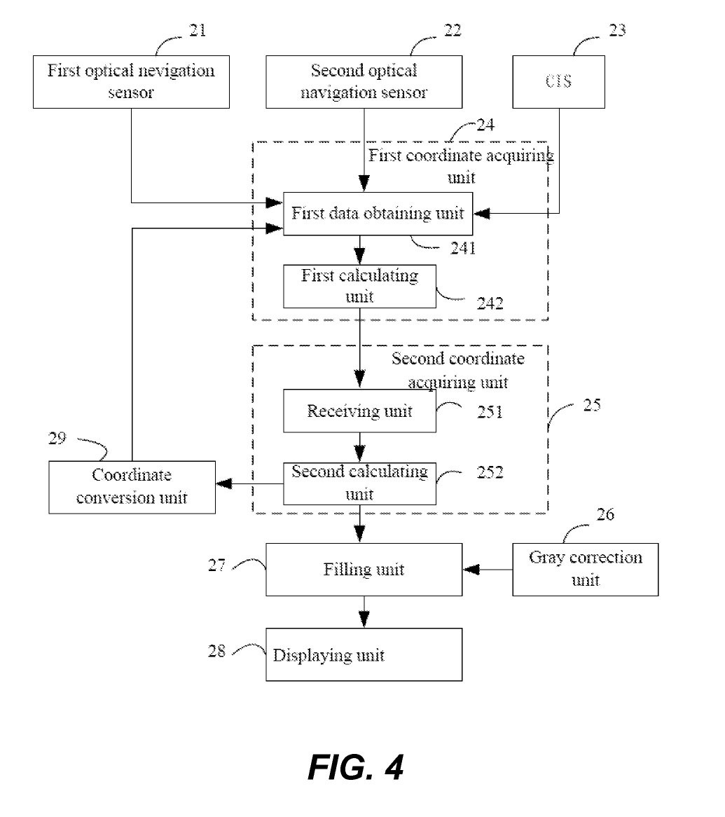

FIG. 4 shows an exemplary system of implementing one embodiment of the present invention. The system includes: a first optical navigation sensor 21 and a second optical navigation sensor 22 for determining the coordinates and angles of a moving object, the linear distance between the two optical navigation sensors 21, 22, where the distance between the two optical navigation sensors is a constant D. The system further includes a contact image sensor 23 for scanning images disposed opposite to or near a line joining the two optical navigation sensors 21, 22.

In one embodiment, the system includes a processor or circuitry configured to function as various functional units. A first coordinate acquiring unit 24 is provided to acquire terminal coordinates (x₁, y₁) and (x_{N}, y_{N}) of the contact image sensor 23 according to respective initial coordinates (x₀₀, y₀₀) and (x₀₁, y₀₁) of the two optical navigation sensors 21, 22 and the positional relationship between the two optical navigation sensors 21, 22 and the contact image sensor 23. A second coordinate acquiring unit 25 is provided to acquire the coordinates (xₙ, yₙ) of a pixel point on the contact image sensor 23 according to the terminal coordinates (x₁, y₁) and (x_{N}, y_{N}) of the contact image sensor 23. A correction unit 26 is also provided to correct deficiency in the acquired image data, for example, for compensating a dead pixel value, correcting a gray value or chromaticity values of a pixel point on the CIS 23, obtaining a corresponding gray or chromaticity responding value of the arbitrary pixel point on the CIS 23 relative to a pure white and a pure black template, and obtaining the correction coefficients of each pixel point.

A filling unit 27 is provided to write a corresponding gray value or chromaticity values of a pixel point in a predetermined buffer area according to the coordinates (xₙ, yₙ) acquired by the second coordinate acquiring unit 25. A displaying unit 28 is optionally provided for real-time displaying the acquired image provided by the filling unit 27. A coordinate conversion unit 29 is provided for determining offsets of the two optical navigation sensors 21, 22 in the X-axis direction and the Y-axis direction after a movement to obtain the current coordinate values of the two optical navigation sensors 21, 22, which are sent to the first coordinate acquiring unit 24 as the initial coordinates (x₀₀, y₀₀) ^{and} (x₀₁, y₀₁) before the next movement.

As described above, the first coordinate acquiring unit 24 acquires the terminal coordinates (x₁, y₁) and (x_{N}, y_{N}) of the contact image sensor 23 according to the positional relationship between the two optical navigation sensors 21, 22 and the contact image sensor 23. The second coordinate acquiring unit 25 then acquires the coordinates (xₙ, yₙ) of a pixel point on the contact image sensor 23. After the correction unit 26 corrects the corresponding gray value or chromaticity value of a pixel point on the CIS 23, the filling unit 27 fills the corrected gray value or chromaticity value of the pixel point in a predetermined buffer area according to the coordinates (xₙ, yₙ) of the pixel point. The displaying unit 28 then displays the image in the buffer. The coordinate conversion unit 29 is designed to obtain the coordinate values of the two optical navigation sensors 21, 22 before each movement, which are taken as the initial coordinates (x₀₀, y₀₀) and (x₀₁y₀₁) before the next movement.

In one embodiment, the two optical navigation sensors 21, 22, the CIS 23 and the first coordinate acquiring unit 24 can be disposed in a scanning device, and the second coordinate acquiring unit 25, the coordinate conversion unit 29, the correction unit 26, the filling unit 27 and the displaying unit 28 can be disposed in a host machine coupled with the scanning device.

As a normal optical mouse has an optical navigation sensor for determining the movement coordinates and angles of the mouse, the scanning device in one embodiment as described above can also be used as a mouse. That is, a transfer switch for switching between a scanning device and a normal optical mouse can be disposed in the mouse. When the mouse is used for scanning, the transfer switch is pressed to activate the function of a scanning device. When the mouse is used for moving a cursor on a computer screen, the transfer switch is pressed again to activate the function of an optical mouse.

Alternatively, the two optical navigation sensors 21, 22, the CIS 23, the first coordinate acquiring unit 24, the second coordinate acquiring unit 25, and the correction unit 26 can be disposed in a scanning device, and the coordinate conversion unit 29, the filling unit 27 and the displaying unit 28 can be disposed in a host machine coupled with the scanning device.

Alternatively, the two optical navigation sensors 21, 22, the CIS 23, the first coordinate acquiring unit 24, the second coordinate acquiring unit 25, the correction unit 26 and the coordinate conversion unit 29 can be disposed in a scanning device, and the filling unit 27 and the displaying unit 28 can be disposed in a host machine coupled with the scanning device.

Alternatively, the two optical navigation sensors 21, 22, the CIS 23, the first coordinate acquiring unit 24, the second coordinate acquiring unit 25, the correction unit 26, the coordinate conversion unit 29 and the filling unit 27 can be disposed in a scanning device, and the displaying unit 28 can be disposed in a host machine connected with the scanning device.

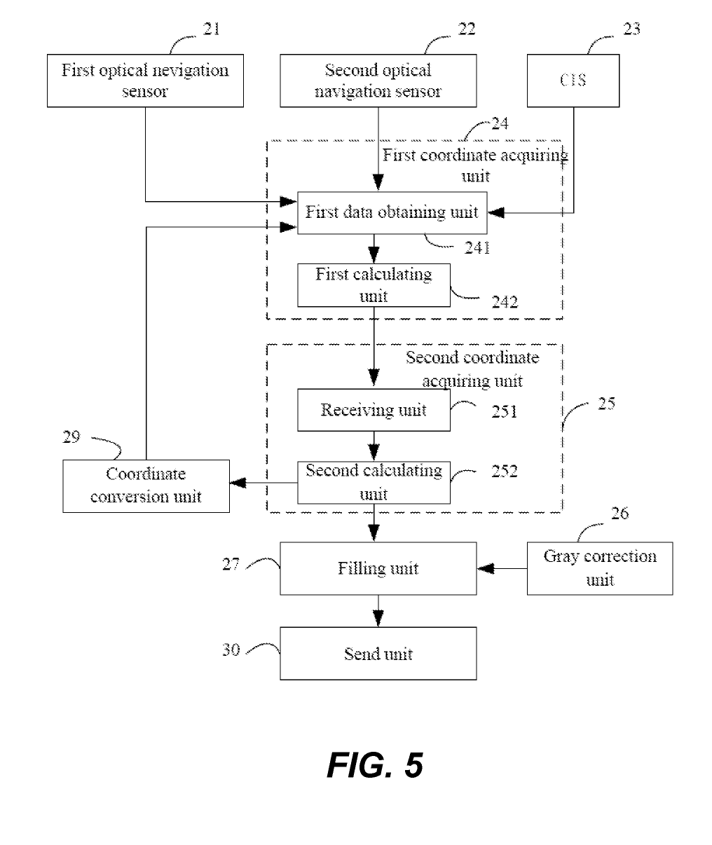

FIG. 5 shows an exemplary scanning device contemplated in the present invention, the scanning device is connected with a host machine to accomplish the scanning function together. The scanning device includes first and second optical navigation sensors 21, 22, a CIS 23 and a first coordinate acquiring unit 24. A transmitting unit 30 is connected with the scanning device.

The first coordinate acquiring unit 24 acquires terminal coordinates (x₁, y₁) and (x_{N}, y_{N}) of the contact image sensor 23 according to the positional relationship between the two optical navigation sensors 21, 22 and the contact image sensor 23. The transmitting unit 30 then transmits the terminal coordinates of the contact image sensor 23 to the host machine that is being connected with the scanning device.

Alternatively, the scanning device may further include a second coordinate acquiring unit 25 for acquiring the coordinates (xₙ, yₙ) of a pixel point on the contact image sensor 23 before each movement according to the terminal coordinates of the contact image sensor 23. The transmitting unit 30 then transmits the acquired coordinate data to the host machine that is connected with the scanning device.

In the scanning process of the CIS 23, as the response of each pixel point on the CIS 23 to the same gray value or chromaticity value is different from each other, correction of the gray value or chromaticity value of each pixel point may be required. Therefore, the scanning device may further include a gray correction unit 26.

Further, the scanning device may include a filling unit 27. Further, the scanning device may include a coordinate conversion unit 29. The filling unit 27 serves to fill the corresponding gray value or chromaticity value of the above arbitrary pixel point in a predetermined buffer area according to its coordinates (xₙ, yₙ). The transmitting unit 30 then real-time transmits the image stored in a buffer area to the host machine for real-time display.

In the scanning process, the coordinate conversion unit 29 serves to obtain the coordinate values of the two optical navigation sensors 21, 22 after each movement. These coordinate values are transmitted to the first coordinate acquiring unit 24 as the threshold coordinates (x₀₀, y₀₀) and (x₀₁, y₀₁) of the two optical navigation sensors 21, 22 before the next movement of the scanning device.

In another embodiment, the scanning device is not connected with a host machine, and thus it accomplishes the scanning function entirely itself. Therefore, the scanning device is a standalone machine. It may include some or all of the components listed in FIG. 4.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claim. Accordingly, the scope of the present invention is defined by the appended claims rather than the forgoing description of embodiments.

What is claimed is:

1. A method for obtaining a scanned image, the method comprising:
(a) acquiring terminal coordinates (x₁, y₁) and (x_{N}, y_{N}) of a contact image sensor according to respective initial coordinates (x₀₀, y₀₀) and (x₀₁, y₀₀) of two optical navigation sensors and a positional relationship between the two optical navigation sensors and the contact image sensor before a relative movement between a scanning device and a scanning object;
(b) acquiring coordinates (xₙ, yₙ) of a pixel point on the contact image sensor;
(c) obtaining a pixel value for each of pixels on the contact image sensor;
(d) determining offsets of the two optical navigation sensors along X-axis direction and Y-axis direction, after the relative movement is made, to obtain current coordinate values of the two optical navigation sensors, wherein the current coordinate values of the two optical navigation sensors are taken as initial coordinates (x₀₀, y₀₀) and (x₀₁, y₀₁) of the two optical navigation sensors before a next relative movement between the scanning device and the scanning object; and
repeating (a) through (d) until the scanning object is completely scanned by the contact image sensor.

2. The method as claimed in claim 1, further comprising correcting the pixel value for each of some of the pixels.

3. The method as claimed in claim 2, wherein the correcting of the pixel value for each of some of the pixels comprises:
obtaining correcting coefficients that have been obtained by scanning a pure white template and a pure black template, and adjusting grey values for the some of the pixels according to the correcting coefficients.

4. The method as claimed in claim 2, wherein the contact image sensor is disposed near the two optical navigation sensors to form a geometric pattern so that the terminal coordinates (x₁, y₁) and (x_{N}, y_{N}) of the contact image sensor are readily determined according to the initial coordinates of the two optical navigation sensors.

5. The method as claimed in claim 4, wherein the obtaining of the pixel value for each of pixels on the contact image sensor comprises: writing the pixel value for each of the pixels into a memory space, and displaying the pixel value for each of the pixels on a display device.

6. The method as claimed in claim 1, wherein the scanning device scanning the object that does not fit upon a scan surface of the scanning device and requires a non-linear scanning path.

7. A scanning device comprising:
first and second optical navigation sensors for determining coordinates and an angle of a scanning object;
a contact image sensor for scanning images disposed near the optical navigation sensors to form a geometry pattern from which two ending coordinates of the contact image sensor are obtained in conjunction with coordinates of the first and second optical navigation sensors that are determined after a relative movement of the contact image sensor and the scanning object;
a coordinate acquiring unit for acquiring coordinates (xₙ, yₙ) of each of pixel points of the contact image sensor in accordance with ; and
a memory space for storing pixel values generated from the contact image as the scanning object is being scanned by the contact image sensor.

8. The scanning device as claimed in claim 7, further comprising a correction unit for correcting some of the pixel values.

9. The scanning device as claimed in claim 8, wherein a corresponding gray value or chromaticity value of one of the pixel points on the contact image sensor is adjusted by the correction unit in accordance with one or more correcting coefficients.

10. The scanning device as claimed in claim 9, wherein the correcting coefficients are obtained in advance by scanning a pure white template and a pure black template.

11. The scanning device as claimed in claim 7, wherein the scanning device is a mouse.

12. The scanning device as claimed in claim 7, further comprising a coordinate conversion unit for determining offset of the two optical navigation sensors in X-axis direction and Y-axis direction after the relative movement.

13. A scanning device comprising:
first and second optical navigation sensors for determining the coordinate and angle of a moving object;
a contact image sensor for scanning images disposed opposite to a line joining the two optical navigation sensors;
a first coordinate acquiring unit for acquiring terminal coordinates (x₁, y₁) and (x_{N}, y_{N}) of the contact image sensor according to respective threshold coordinates (x₀₀, y₀₀) and (x₀₁, y₀₁) of the two optical navigation sensors and the positional relationship between the two optical navigation sensors and the contact image sensor before movement;
a second coordinate acquiring unit for acquiring the coordinate (xₙ, yₙ) of an arbitrary pixel point of the contact image sensor in a global coordinate system;
a filling unit for filling the corresponding gray value or chromaticity value of the arbitrary pixel point in a predetermined buffer area according to the coordinate (xₙ, yₙ) acquired by the second coordinate acquiring unit;
a displaying unit for real-time displaying the filled image provided by the filling unit; and
a coordinate conversion unit for summing up offset amounts of the two optical navigation sensors in the X-axis direction and the Y-axis direction after movement to obtain the current coordinate values of the two optical navigation sensors which are sent to the first coordinate acquiring unit as the threshold coordinates before the next movement.

14. The scanning device as claimed in claim 13, further comprising a gray correction unit for gray correcting the corresponding gray value or chromaticity value of the arbitrary pixel point on the contact image sensor, obtaining a corresponding gray or chromaticity responding value of the arbitrary pixel point on the contact image sensor relative to a pure white template and a pure black template and obtaining the correction coefficient of each pixel point based on the above responding value to realize correction of the gray or chromaticity responding value.
